(19) United States
(12) Patent Application Publication
(10) Pub. No.: US 2020/0008584 A1
(43) Pub. Date: Jan. 9, 2020

(54) USE OF NON-NEWTONIAN FLUID IN MATTRESS FOR RESUSCITATION AND PRESSURE DIFFUSION

(71) Applicant: General Electric Company, Schenectady, NY (US)

(72) Inventor: Anirban Ghosh, Bengaluru (IN)

(73) Assignee: General Electric Company, Schenectady, NY (US)

(21) Appl. No.: 16/026,241

(22) Filed: Jul. 3, 2018

(51) Int. Cl. A47C 27/08; A61G 7/05

(52) U.S. Cl. CPC A47C 27/085; A61G 7/05

(57) ABSTRACT

An infant care device and mattress for use with the infant care device for supporting the weight of an infant during normal use and during resuscitation. The mattress includes a non-Newtonian fluid that supports the weight of the infant. The non-Newtonian fluid allows the mattress to act as a pressure diffusing mattress when the infant patient is placed on the mattress for an extended period of time. The non-Newtonian fluid reacts to a force applied to the mattress, such as during resuscitation, such that the non-Newtonian fluid stiffens and provides the required support for the infant during such resuscitation. The non-Newtonian fluid is contained in one or more flexible pouches positioned within a mattress body. The mattress of the present disclosure thus replaces the need for a separate foam mattress and pressure diffusing mattress.

### BACKGROUND

The present disclosure generally relates to a mattress designed for use in an infant care device to support an infant patient. More specifically, the present disclosure is directed to a mattress that can simulate the properties of both a foam mattress and a pressure diffusing mattress.

Premature infants are often placed within an infant care device, such as an incubator, so that they may have a controlled and monitored environment to aid in their survival and growth. Premature infants are fragile and, as such, are highly susceptible to stress placed upon them each time they are disturbed by physical contact such as is required during lifting, moving or performing tests. This stress can contribute to a higher incidence of complications and possibly extend the hospital stay. Studies have shown that neonates, on average, get less than thirty minutes per day of quality rest. Infants that receive more rest are shown to recover faster.

Nevertheless, it is often necessary to physically contact the infant, such as during treatment or in an emergency situation. In an emergency situation, manual resuscitation may be required, which requires compressions to be applied to the chest of the infant.

Currently, two types of mattresses are used in the NICU. One type is a foam mattress which is used to support the neonate and is mostly used for a short term, such as during resuscitation. A foam mattress functions well for resuscitation since the mattress does not comply upon the application of force to an infant supported on the mattress. The downside of using such a foam mattress is that it can cause damage to the delicate skin of the neonate if the neonate is left on the foam mattress for extended periods of time because of the relatively hard surface.

To prevent damage to the neonate's skin tissue, a pressure diffusing mattress is used for extended support of the neonate. An example of a pressure diffusing mattress is the Giraffe® pressure diffusing mattress available from GE Healthcare. In this case, the mattress includes multiple layers of foam that are designed to diffuse the pressure applied by the weight of the infant and complies to the force being applied on it due to the weight of the infant. However, since this kind of mattress is softer, it is not desirable for use during resuscitation.

An issue which arises is that after resuscitation, the neonate has to be transferred from the foam mattress to the pressure diffusing mattress, which could lead to excessive touch to the neonate's skin which has been found to be detrimental to the neonate's development. The present disclosure contemplates the use of a mattress which combines the functionality of both types of mattresses into one to help eliminate the damage to the neonate during transfer from one mattress to another.

### SUMMARY

The present disclosure is directed to a mattress which can act to simulate the properties of both a foam mattress and a pressure diffusing mattress. A foam mattress is typically used during resuscitation of an infant patient and a pressure diffusing mattress is typically used to reduce stress on a neonatal infant patient's back during extended periods of support. A pressure diffusing mattress does not offer sufficient support to support a neonate's back while the pressure diffusing mattress provides the required support. A foam mattress can be used for resuscitation while the pressure diffusing mattress cannot. Depending on the therapy being given, the neonate is transferred from one mattress to another.

To remove the requirement of moving the neonate from one mattress to another, the present disclosure combines the functionality of both types of mattresses into one. This can be achieved by using a non-Newtonian fluid instead of foam for the mattress. During normal use, the mattress is soft and will diffuse the pressure on the neonate's back as the fluid distributes the weight over the entire mattress. During resuscitation, the sudden pressure on the mattress increases the viscosity of the fluid, which has the effect of hardening the mattress at the point of application of the force hence delivering an effective platform for resuscitation of the neonate. This is achieved by the property of a non-Newtonian fluid to change viscosity depending on the pressure being applied over the surface of the liquid. If a gradual pressure is applied, then the liquid behaves as a fluid and when a sudden pressure is applied, the fluid behaves like a solid.

A wide variety of non-Newtonian fluids of the shear thickening variety could be used in accordance with the present disclosure. Whichever type of non-Newtonian fluid is selected, the fluid must become more viscous upon the application of pressure yet remain less viscous during normal use.

The mattress can be designed with sidewalls that create an open interior that receives the supply of non-Newtonian fluid. The fluid could be contained within a flexible pouch or other type of container that prevents direct contact between the non-Newtonian fluid and the skin of the neonate. The mattress could have a thin layer of material between the pouch and the neonate to increase comfort during normal use.

The mattress constructed in accordance with the disclosure could be used within infant warmers, incubators or bassinets for neonatal or infant patients. The mattress of the present disclosure would replace current mattresses in both infant warmers and incubators and would allow for extended support of the patient while facilitating resuscitation.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is an environmental view of an infant care device;

FIG. 2 is a detailed view of the infant care device including various monitoring components and a mattress for supporting an infant patient;

FIG. 3 is a section view of a first embodiment of the mattress according to one embodiment of the disclosure;

FIG. 4 is a section view of a second embodiment of the mattress in accordance with the present disclosure;

FIG. 5 is a section view of a third embodiment of the mattress in accordance with the present disclosure; and

FIG. 6 is a graph illustrating the relationship between shear stress and shear rate in a non-Newtonian fluid.

### DETAILED DESCRIPTION

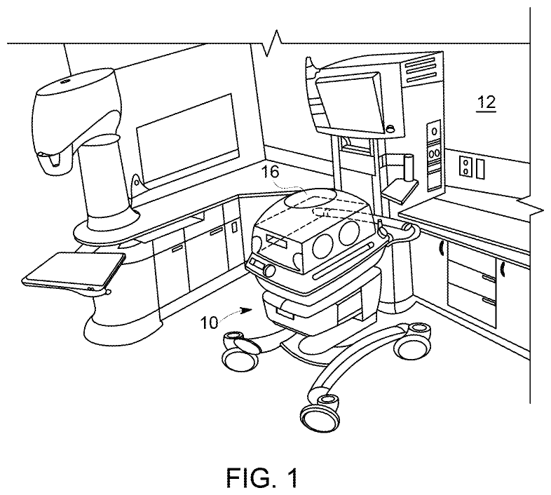

FIG. 1 illustrates one embodiment of an infant care device 10 that incorporates a mattress constructed in accordance with the present disclosure. In the embodiment shown in FIG. 1, the infant care device 10 is located within a patient's room 12, which may be part of a neonatal intensive care unit (NICU). The infant care device 10 shown in FIG. 1 can be many different types of devices, such as an incubator-type infant care apparatus or a patient warmer. The infant care device 10 shown in FIG. 1 creates a microenvironment region 16 in which the patient rests and receives therapy, including heating and possible oxygen enrichment.

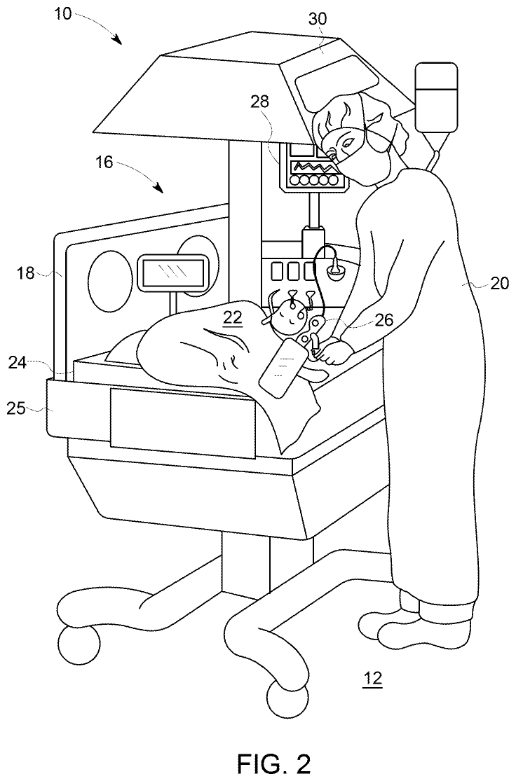

Referring now to FIG. 2, the side 18 of the infant care device 10 can be lowered such that a caregiver 20 can have access to an infant 22 positioned on the mattress 24 supported on a platform 25. Various different patient sensors 26 can be attached to the infant such that the infant care device 10 can monitor physiological parameters from the infant. The monitored physiological parameters can be shown on a display 28 and can be viewed by the caregiver 20. As described previously, it is desirable that the infant 22 can remain within the microenvironment created by the infant care device 10 such that the infant patient does not need to be lifted from the mattress 24 and is disturbed as infrequently as possible.

While the infant patient 22 is supported on the mattress 24, there may be an emergency need to perform resuscitation on the infant patient 22. Such resuscitation typically includes applying pressure to the chest of the infant patient while the infant patient 22 is supported on the mattress 24. For such situations, it is desirable for the mattress 24 to be sufficiently firm such that the mattress 24 does not give upon the application of force to the infant patient 22.

During normal situations where resuscitation is not needed, it is desirable that the mattress 24 be sufficiently compliant such that the mattress 24 diffuses the force applied to the mattress 24 by the weight of the infant patient 22.

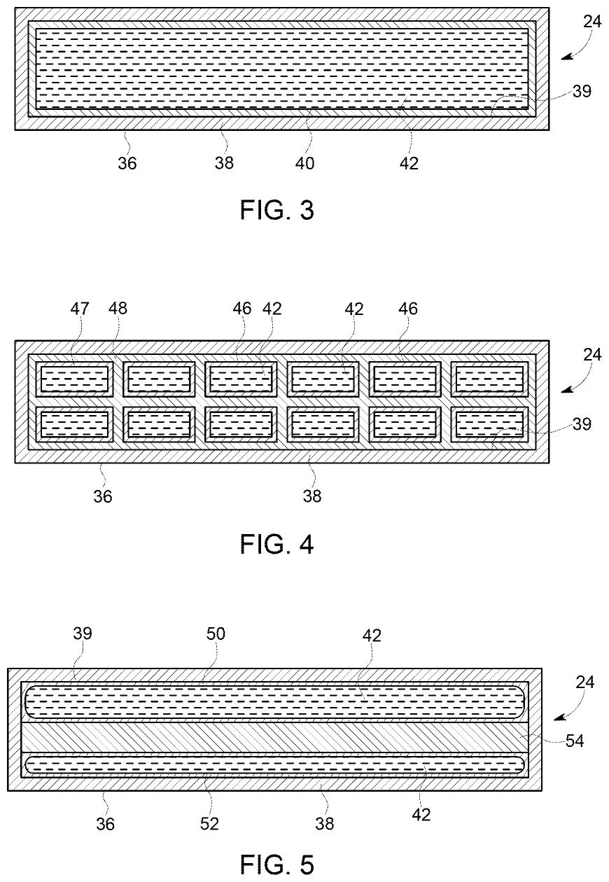

As described above, the infant care device 10 of the present disclosure includes a mattress 24 that is specifically designed such that the mattress 24 can be used to support the infant patient for extended periods of time and can also be used to support the infant patient during resuscitation. FIG. 3 illustrates a section view of a first embodiment of the mattress 24 constructed in accordance with the present disclosure. In the embodiment shown in FIG. 3, the mattress 24 includes a mattress body 36 having an outer layer 38 formed from a thin layer of foam material. The outer layer 38 creates an open interior 39 that is sized to receive and surround a fluid pouch 40 that includes a contained supply of a non-Newtonian fluid 42. The flexible pouch 40 can be formed from a variety of materials, such as plastic, that are impervious to the non-Newtonian fluid 42 and are durable to prevent puncture and/or leakage. The non-Newtonian fluid 42 is contained within the pouch 40, which in turn is surrounded by the outer layer 38 of foam. The non-Newtonian fluid 42 contained within the fluid pouch 40 is generally free-flowing within the pouch 40 such that the non-Newtonian fluid is able to flow in response to the movement of an infant patient supported on the mattress 24. The thickness of the outer layer 38 is selected such that the material properties of the foam used to form the outer layer 38 does not limit the ability of the non-Newtonian fluid 42 to support the infant patient in a pressure-diffusing manner.

In accordance with the present disclosure, the non-Newtonian fluid is defined as a fluid that does not follow Newton's Law of Viscosity. Specifically, the viscosity of a non-Newtonian fluid is dependent on the shear rate applied to the fluid rather than a normal fluid in which the shear stress is directly proportional to the shear rate. In normal fluids, the viscosity is constant while in a non-Newtonian fluid, the relationship between shear stress and shear rate is not directly proportional.

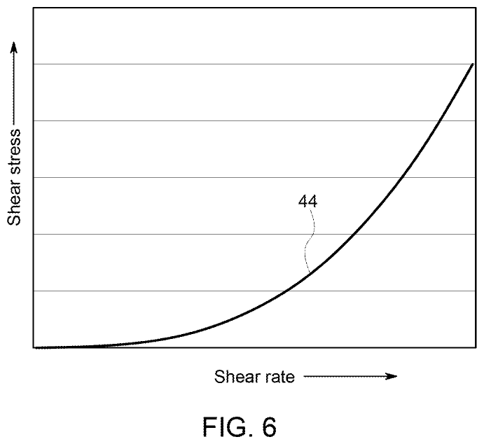

FIG. 6 illustrates the relationship for a non-Newtonian fluid, as represented by curve 44, between the shear stress and shear rate. As can be seen in FIG. 6, the shear stress increases at a very fast rate (almost exponentially) with the applied pressure, which results in the fluid taking an almost solid form at high levels of shear rate. Although there are many different types of non-Newtonian fluids, it is contemplated that the non-Newtonian fluid 42 shown in FIG. 3 could be PVA plus Borax, a silica suspension in polyethylene Glycol or other similar compositions.

Generally, the non-Newtonian fluid is a colloid made up of two parts, a base liquid and a particulate suspension. When a lower amount of force is applied to the top of the mattress and thus to the non-Newtonian fluid 42, the particles in the non-Newtonian fluid move through the base fluid without interacting with each other to a large degree. During this low application of force, the non-Newtonian fluid acts as a fluid and can support the infant patient.

However, when a large force is applied quickly, such as during resuscitation of the infant patient, the pressure applied to the surface of the non-Newtonian fluid overwhelms the repulsive forces and the particles contained within the non-Newtonian fluid clump together to form a harder structure (hydroclusters) which results in a large increase in viscosity as can be seen in the diagram of FIG. 6. The viscosity in FIG. 6 is the slope of the curve 44 at any point along the curve. Once the force has been removed from the surface of the non-Newtonian fluid, the hydroclusters break up and again allow the non-Newtonian fluid behave as a fluid. Thus, the use of the non-Newtonian fluid within the pouch 40 in the mattress 24 shown in FIG. 3 allows the fluid to act as a true fluid during normal situations and form a much harder structure when the shear rate increases, such as during chest compressions or resuscitation of the infant patient.

FIG. 4 illustrates a second, contemplated embodiment of the mattress 24. The mattress 24 again includes the mattress body 36 having an open interior 39 defined by the outer layer 38 of a thin foam material. The outer layer 38 provides a comfortable surface to support the infant while not affecting the function and reaction of the remaining portions of the mattress. The mattress 24 in FIG. 4 includes a plurality of fluid cells 46 that each receive a pouch 47 that includes a supply of the non-Newtonian fluid 42. The non-Newtonian fluid 42 contained in each of the fluid cells 46 is of large enough volume such that the non-Newtonian fluid 42 can freely flow within each of the separate fluid cells 46. The fluid cells 46 are separated from each other by a lattice structure 48. Preferably, the lattice structure 48 is formed from a foam material and separates each of the fluid cells 46. It is contemplated that the non-Newtonian fluid would be contained within separate fluid pouches 47 that are each received within one of the fluid cells 46. In this manner, the non-Newtonian fluid can be contained within the flexible pouch 47 and inserted into one of the fluid cells 46. Such design would allow the non-Newtonian fluid to harden under stress while providing for a durable design for the mattress 24.

FIG. 5 illustrates yet another embodiment of the mattress 24 constructed in accordance with the present disclosure. In the embodiment shown in FIG. 5, the mattress 24 again includes the mattress body 36 having an open interior 9 defined by the foam outer layer 38. However, in the embodiment shown in FIG. 5, an upper pouch 50 and a lower pouch 52 are separated by a foam layer 54. The foam layer 54 provides separation between the upper pouch 50 and the lower pouch 52. The upper pouch 50 and lower pouch 52 are each filled with the non-Newtonian fluid. The use of the foam layer 54 provides additional stability for the mattress during normal use while the upper and lower pouches 50, 52 including the non-Newtonian fluid 42 allows the non-Newtonian fluid 42 to stiffen and support the infant patient during compressions or resuscitation.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A mattress for use in supporting an infant patient, comprising:
a mattress body having a open interior surrounded by a series of outer walls; and
a non-Newtonian fluid positioned in the open interior of the mattress body for supporting the infant patient when the infant patient is placed on the mattress.

2. The mattress of claim 1 wherein the non-Newtonian fluid is a shear thickening fluid in which the shear stress of the fluid increase in a non-linear manner based on a shear rate of a force applied to the non-Newtonian fluid increases.

3. The mattress of claim 1 wherein the non-Newtonian fluid is contained within a flexible pouch sized to be received within the open interior of the mattress body.

4. The mattress of claim 1 wherein the mattress includes a pair of flexible pouches each containing the non-Newtonian fluid and positioned within the open interior.

5. The mattress of claim 4 wherein the pair of flexible pouches are separated by a layer of foam.

6. The mattress of claim 1 further comprising:
a plurality of fluid cells formed within the open interior of the mattress body; and
a plurality of fluid pouches each positioned within one of the plurality of fluid cells, wherein each of the fluid pouches includes the non-Newtonian fluid.

7. The mattress of claim 6 wherein the plurality of fluid cells are formed by lattice member.

8. The mattress of claim 7 wherein the lattice member is formed from foam and is removable from the open interior of the mattress body.

9. The mattress of claim 1 wherein the non-Newtonian fluid is selected from a group consisting of PVA and borax and a silica suspended in polyethylene Glycol.

10. An infant care device for use with an infant patient comprising:
a plurality of sensors operable to monitor physical parameters of the infant patient; and
a mattress sized to support the infant patient within the infant care device, the mattress comprising:
a mattress body having a open interior surrounded by a series of outer walls; and
a non-Newtonian fluid contained in the open interior of the mattress body for supporting the infant patient when the infant patient is placed on the mattress.

11. The infant care device of claim 10 wherein the non-Newtonian fluid is contained within a flexible pouch sized to be received within the open interior of the mattress body.

12. The infant care device of claim 10 wherein the mattress includes a pair of flexible pouches each containing the non-Newtonian fluid and positioned within the open interior.

13. The infant care device of claim 12 wherein the pair of flexible pouches are separated by a layer of foam.

14. The infant care device of claim 10 further comprising:
a plurality of fluid cells formed within the open interior of the mattress body; and
a plurality of fluid pouches each positioned within one of the plurality of fluid cells, wherein each of the fluid pouches includes the non-Newtonian fluid.

15. The infant care device of claim 14 wherein the plurality of fluid cells are formed by lattice member.

16. A mattress for use in supporting an infant patient, comprising:
a mattress body; and
a non-Newtonian fluid contained in the mattress body for supporting the infant patient when the infant patient is placed on the mattress.

17. The mattress of claim 16 wherein the non-Newtonian fluid is contained within a flexible pouch.

18. The mattress of claim 16 wherein the mattress includes a pair of flexible pouches each containing the non-Newtonian fluid and a layer of foam positioned between the pair of flexible pouches.

19. The mattress of claim 16 further comprising:
a plurality of fluid cells formed within the mattress body; and
a plurality of fluid pouches each positioned within one of the plurality of fluid cells, wherein each of the fluid pouches includes the non-Newtonian fluid.

20. The mattress of claim 19 wherein the plurality of fluid cells are formed by lattice member.
